(19) United States
(12) Patent Application Publication
(10) Pub. No.: US 2015/0261828 A1
(43) Pub. Date: Sep. 17, 2015

(54) METHOD TO PROPAGATE A MESSAGE IN A REAL TIME INTEREST BASED SOCIAL GROUP

(71) Applicant: SIVA PRAKASA REDDY PAPPULA, FREMONT, CA (US)

(72) Inventor: SIVA PRAKASA REDDY PAPPULA, FREMONT, CA (US)

(21) Appl. No.: 14/217,335

(22) Filed: Mar. 17, 2014

(51) Int. Cl. G06F 17/30; G06Q 50/00; H04L 29/06

(52) U.S. Cl. CPC G06F 17/30522; H04L 65/403; G06Q 50/01

(57) ABSTRACT

A method to establish a social group in real time is provided. The method comprises collection of a user's interest information through a software application provided on the user's computing device. The method further matches the user's interest query with interest information of other users kept in the main system server. The system server then identifies various users having common interest information as that of the user and creates a social group of such users.

### CROSS-REFERENCE(S) TO RELATED APPLICATIONS

This application takes priority from U.S. provisional application No. 61/802,106 filed on 15^{th} Mar. 2013

### TECHNICAL FIELD

This disclosure generally relates to social networking, and more particularly to formation of a social group based on real time intent of a user.

### BACKGROUND

The popularity and growth of social network sites and services has increased dramatically over the last few years. Existing social network sites include Facebook, Google+, Twitter, MySpace, YouTube, LinkedIn, Flicker, Jaiku, MYUBO, Bebo and the like. Such social networking sites are typically organized around user profiles and/or collections of content accessible by members of the network. Membership in such social networks is comprised of individuals, or groupings of individuals, who are generally represented by profile pages and permitted to interact as determined by the social networking service.

In many popular social networks, especially profile-focused social networks, activity centres on web pages or social spaces that enable members to communicate and share activities, interests, opinions, status updates, audio/video content, etc. across networks of contacts. Social networking services might also allow members to track certain activities of other members of the social network, collaborate, locate and connect with former acquaintances and colleagues, establish new connections with other members and share various kinds of information among its members.

While social networks are usually comprised of individuals, members might also include companies, restaurants, political parties and event profiles that are represented in a like manner to human members (e.g., profile pages accessible by members of a social network). Individual members typically connect to social networking services through existing web-based platforms via a computing device and/or mobile smartphone. Smartphone and games-based mobile social networking services are other rapidly developing areas.

Whereas, the social networks have made it easy to share information among its users, however, constantly there is a need of presenting the ever increasing information in a better way.

### SUMMARY

The following presents a simplified summary of the subject invention in order to provide a basic understanding of some aspects of the subject invention. This summary is not an extensive overview of the subject invention. It is not intended to identify key/critical elements of the subject invention or to delineate the scope of the subject invention. Its sole purpose is to present some concepts of the subject invention in a simplified form as a prelude to the more detailed description that is presented later.

According to an embodiment of the invention a method to form a social group based on a real time intent information generated by a user is provided. The method further identifies other users having related information to the real time intent query information generated by the user and forms a group real time so as to facilitate exchange of various information.

To the accomplishment of the foregoing and related ends, certain illustrative aspects of the subject invention are described herein in connection with the following description and the annexed drawings. These aspects are indicative, however, of but a few of the various ways in which the principles of the subject invention may be employed and the subject invention is intended to include all such aspects and their equivalents. Other advantages and novel features of the subject invention may become apparent from the following detailed description of the subject invention when considered in conjunction with the drawings.

### BRIEF DESCRIPTION OF THE DRAWINGS

Reference will be made in detail to embodiments of the disclosure, non-limiting examples of which may be illustrated in the accompanying drawing figures (FIGS.). The figures may be in the form of diagrams. Some elements in the figures may be exaggerated or drawn not-to-scale; others may be omitted, for illustrative clarity. Any text (legends, notes, reference numerals and the like) appearing on the drawings are incorporated by reference herein. When terms such as “left” and “right”, “top” and “bottom”, “upper” and “lower”, “inner” and “outer”, or similar terms are used in the description, they may be used to guide the reader to orientations of elements in the figures, but should be understood not to limit the apparatus being described to any particular configuration or orientation, unless otherwise specified or evident from context. Different “versions” of elements may be referenced by reference numerals having the same numbers (###) followed by a different letter suffix (such as “A”, “B”, “C”, or the like), in which case the similar elements may be inclusively referred to by the numeric portion (###) only of the reference numeral

FIG. 1 illustrates the implementation of a social group.

FIG. 2 illustrates exemplary specific entities that can be formed using the invention.

FIG. 3a illustrates the connection permissions within a social group as according to an embodiment of the invention.

FIG. 3b illustrates various derived privileges between various interconnected social groups in accordance to an embodiment of the invention

FIG. 4 depicts the various access based roles and privileges available to various categories of users.

FIG. 5 illustrates a specific example of sharing messages across interconnected social groups.

FIG. 6 depicts member to member communication within the social group for a specific entity.

FIG. 7 illustrates an individual user as a specific entity.

FIG. 8 illustrates the formation of sub entities within a social group.

FIG. 9 depicts the messaging system. Messaging clients send the message to the messaging system for further processing

FIG. 9a illustrates the registration schema of the provider

FIG. 9b illustrates the registration schema of the requester

FIG. 9c illustrates the flow chart of the messaging system to send the message

FIG. 9d illustrates the flow chart of the requester receiving message

FIG. 9e illustrates the flow chart of the messaging system processing email clients message

FIG. 9f show the different options stored along with emails, newsgroup, websites and social groups so that interoperation can take place

FIG. 9g show the deliver methods followed by the messaging system.

FIG. 10 illustrates an example operating environment in which the invention may function.

FIG. 11 is a schematic block diagram of a sample-computing environment

### DETAILED DESCRIPTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

The embodiments and aspects thereof may be described and illustrated in conjunction with systems, devices and methods which are meant to be exemplary and illustrative, not limiting in scope. Specific configurations and details may be set forth in order to provide an understanding of the invention(s).

However, it should be apparent to one skilled in the art that the invention(s) may be practiced without some of the specific details being presented herein. Furthermore, some well-known steps or components may be described only generally, or even omitted, for the sake of illustrative clarity.

Reference herein to “one embodiment”, “an embodiment”, or similar formulations, may mean that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

As used in this application, the terms “component,” “handler,” “model,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). Computer components can be stored, for example, on computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the subject invention.

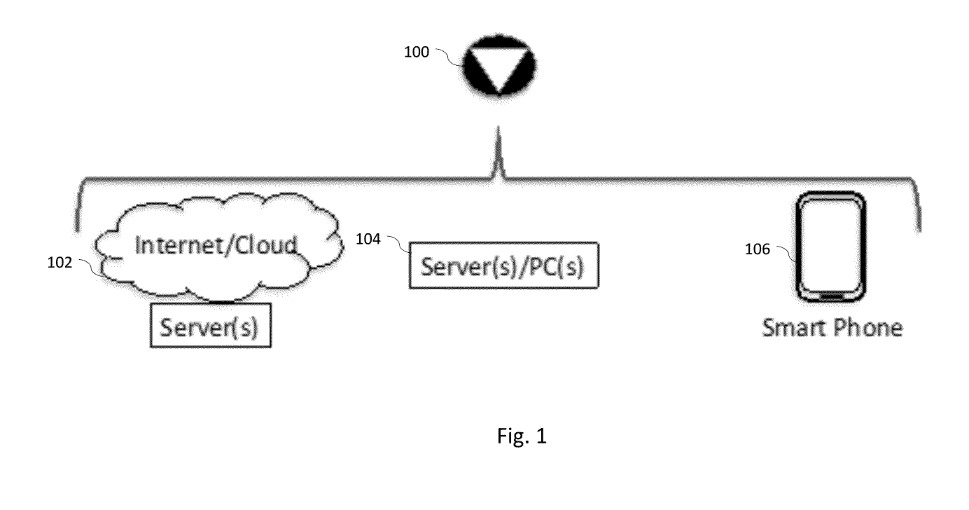

Referring to FIG. 1, which depicts the formation of a social group 100 in various ways. In one embodiment of the invention the social group 100 is implemented through a mobile device 106. This can be achieved through a mobile application on the mobile application. In furtherance to this the implementation to this embodiment can also be achieved by storing some of the content on cloud 102. The information of the social group 100 can be propagated using REST framework or JSON or XML coding.

The logic for creation of the social group 100 can also be stored in various plugins or extensions into any existing mobile applications. The implementation ca also be achieved through web based applications. For this to achieve the process is hosted on a remote server which can be accessed via various protocols such as HTTP/HTTP(s). The logic for creation of the social group 100 can also be written within the applications made for various social media platforms.

In another embodiment of the invention, the social group 100 can also be implemented through a personal computer 104.

The social group 100 however not limiting to the scope of the invention, an application software system. As described above the social group 100 can be implemented as an application running on a mobile device 106 or a personal computer 104 running as an application running on various mobile platforms such as iPhone, Android, Microsoft tablet and other types of computer systems which have given memory and ability to interact with users. The application software system residing on a main server (not shown in the figure) maintains certain information about the social group 100 which may be, however not limiting to the scope of the invention, type of the social group 100, name, certain identifiers, description, keywords, databases, files and objects, users privileges and roles, message filter rules, settings, current location of a user, location history of the user, and other information. The mobile devices 106 or the personal computer 104 can contact the main server to locate other relevant virtual specific entities and gather information about the social group 100. In some embodiments the mobile device 106 may cache various information related to the social group 100 to improve performance and responsiveness to users. Social group systems servers can be implemented as single or groups of servers with facility to back the information, distribute the load and provide high resilience against various failures. In some embodiments, the social group 100 can be created manually, by user specifying the entity details. In other embodiments, the social group 100 may be created automatically by system. For example, automatically creating a social group for all restaurants in a given area. In yet another embodiment of the invention various other social groups can be connected to the social group 100. Also, in some embodiments the social group 100 can be connected to email, web and other interfaces as well.

### Explanation for Connection Formation of Social Groups:

### Static Connection Formation:

A user may request to identify a set of relevant social groups based on certain key terms or keywords or any other information or any combination thereof. The request of the user is taken by the software application and forwarded to the main server. The main server returns to the user, results related to the query input from him. A set of social groups presented to the user after which if the user may wish he may select either one of the social groups or multiple social groups as per his interest to join. Therefore, the user may also join multiple social groups at a time.

### Dynamic Connection Formation:

As mentioned above in the description connecting to the social group 100, enables users to gather relevant information and discussion. Therefore, dynamic connection formation is provided in order to provide the user facility to find relevant information when he is on the move. This may be based on context, such as events, activities or other interests of the user. The information of the virtualized social entity system is updated so as to indicate the dynamic connections at any point of time as per the user's movement. In one embodiment of the invention the social group 100 can automatically connect to a nearby other virtualized social entities. Connection can be based on user's interest/history or through user's explicit search request. Also, optionally the connection may be automatically terminated when the user is physically away or is not active, from the virtualized social entity to which he was connected dynamically.

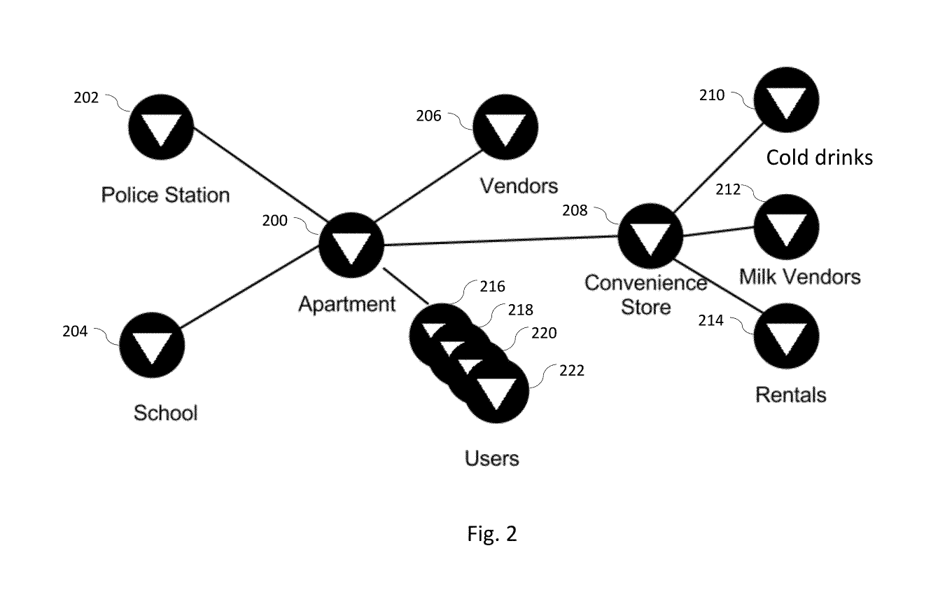

Moving onto FIG. 2, which illustrates a social group 200 connected to another social group 208 and the various services available to the users 216, 218, 220 and 222 within these connected groups. In an exemplary embodiment of the invention, however not limiting to the scope of the invention, a social group could be an apartment 200 which has further other various social groups like police station group 202, school group 204, vendors group 206 like plumber, electrician etc., convenience store group 208 which is further connected to cold drinks services group 210, milk vendors group 212, and rentals group 214 which could be video renting etc. The various users 216, 218, 220 and 222 who are connected to the apartment group 200 can access services in the groups which are connected to the apartment group 200. Hence, a facility is provided to join large number of social groups at once. In the way of example, search for social group can be done using distance as a measure i.e. list all the specific groups which are within 50 miles radius. Once the list of specific groups is returned, user can decide to join all the social groups which are retuned by the query. Social groups can be identified through various factors such as topic of interest, physical distance and other means. Once the social group is detected a request to join the social group is made. In some embodiments, this is accomplished by clicking “Join” button on the screen of a computing device or through a gesture on a touch screen device.

In another embodiment of the invention, connecting to social group helps in gathering relevant information and discussion. To support scenarios where the user is on move and wants to find relevant information based on nearby specific entities or based on context, such as events, activity or other interests, dynamic connections of specific entities is allowed. In one embodiment a given virtual specific entity automatically connects to a nearby specific entities. Optionally, when user is physically away from a dynamically connected social group without any activity then user's connection to a given social group is removed. The users connected with the social group are able to share messages which can be anyone of conversations, chats, news, information, reviews, recommendations, and, questions amongst themselves. The messages shared can be categorized as anyone, but not limiting to the scope of the invention as a global message, a shared message, or a private message.

In yet another embodiment of the invention, in cases where a forum that results into a social group does not have a true physical association i.e. there may be users from various locations of the world who want to participate in a group etc. This forum may be represented as a social group. Users associated with this social group may also be optionally organized into further sub groups with basic attributes for e.g. physical location of users, interests of users etc. Such a sub grouping enables creation of a local sub group so as to enable interaction between local users as well.

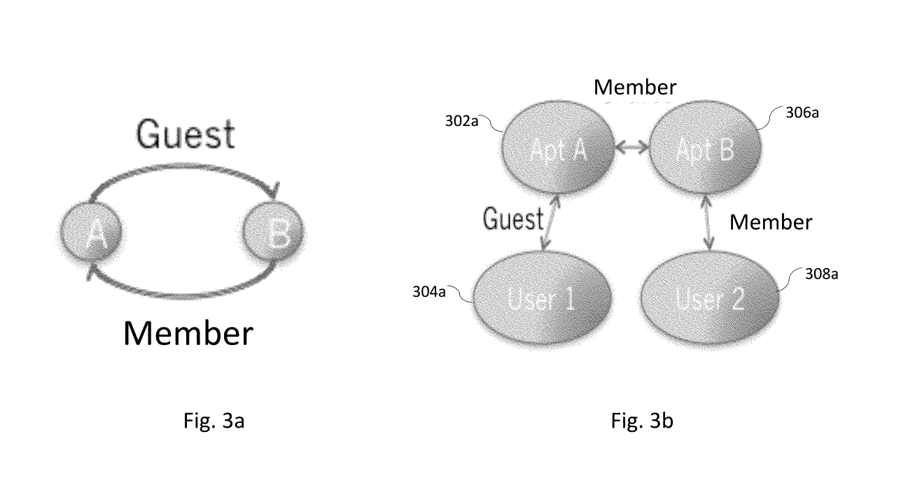

FIG. 3a illustrates the connection permissions within a social group connected to a social group. In an embodiment of the invention a social group can be formed automatically by a system or manually by a user. When a new social group is formed and is connected to another social group then, only public information is accessible by default. Through various authorization methods, other privilege levels such as a member or an owner can be obtained. In one embodiment, this is implemented by user sending an access level request to existing owners. Owner on viewing the request decides the right privilege level for the user.

In another embodiment of the invention different level of access is provided as well Specific Example: as shown in the FIG. 3a user A might have guest level permission on B, but B might have member level access to user A.

FIG. 3b illustrates various derived privileges between various interconnected social groups in accordance to an embodiment of the invention. In an embodiment of the invention Apartment A 302a (depicted as Apt A) is a social group which is connected to Apartment B (depicted as Apt B) 306a. User1 304a belongs to a social group for Apt A 302a. User2 belongs to a social group for Apt B 306a. User1 304a has guest access to Apt A 302a. User2 has member level access to Apt B. Even though Apt A and Apt B have member privilege, User1 will only get guest level access to Apt B.

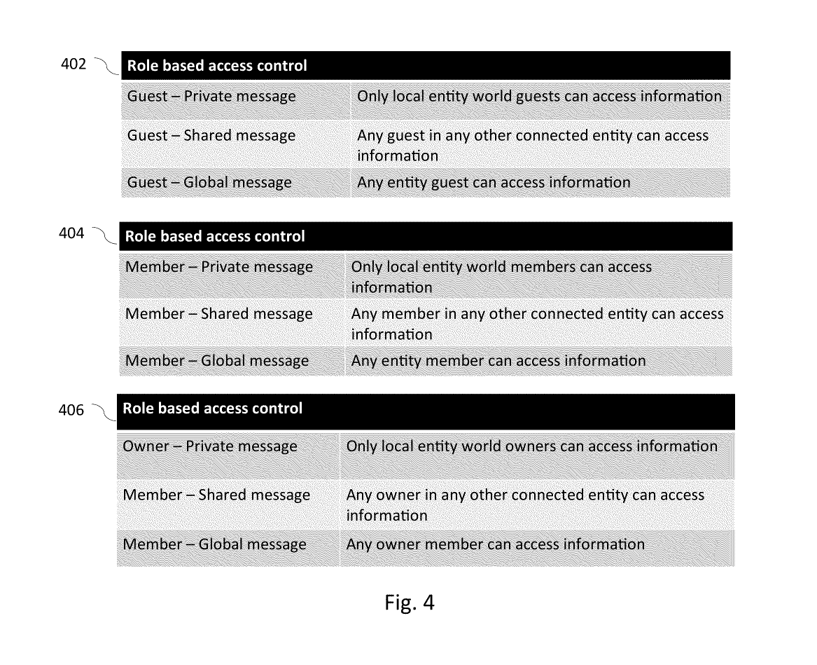

Referring to FIG. 4, it depicts tables to illustrate various types of access that can be provided to users with various types of roles. References will be made to FIG. 2 to explain the context of the invention. As shown in table 402, the role based access control for a user assigned with a guest role within the social group connected to the social group 100. As mentioned above in the description, the information posted by the user can also be further classified into various categories. As table 402 depicts when a guest user posts a private message to the social group 100, this message can be accesses by only those guest users which are connected to the social group 100. However, if the guest user posts a message classified as a shared message to the social group 100, then this message can be accessed by any guest user in any social group connected to the social group 100. Furthermore, if the guest user posts a message classified as a global message, then any guest in any social group can whether connected to the social group 100 or not, can access the message. This is because one user may be connected to multiple specific entities which might or might not be connected to each other.

Further as depicted in table 404 when a member user posts a private message to the social group 100, this message can be accesses by only those member users which are connected to the local social group 100. However, if the member user posts a message classified as a shared message to the social group 100, then this message can be accessed by any member user in any social group connected to the social group 100. Furthermore, if the member user posts a message classified as a global message, then any member in any social group can whether connected to the social group 100 or not, can access the message. This is because one user may be connected to multiple specific entities which might or might not be connected to each other.

Further as depicted in table 406 when an owner user posts a private message to the social group 100, this message can be accesses by only those owner users which are connected to the local social group 100. However, if the owner user posts a message classified as a shared message to the social group 100, then this message can be accessed by any owner user in any social group connected to the social group 100. Furthermore, if the owner user posts a message classified as a global message, then any owner in any social group can whether connected to social group 100 or not, can access the message. This is because one user may be connected to multiple social groups which might or might not be connected to each other.

In another embodiment of the invention, various roles can also be assigned to various connected social groups. For e.g. as depicted in FIG. 2 the Apartment social group 200 which is connected to Police station social group 202 can have anyone of an owner role, a guest role, or a member role.

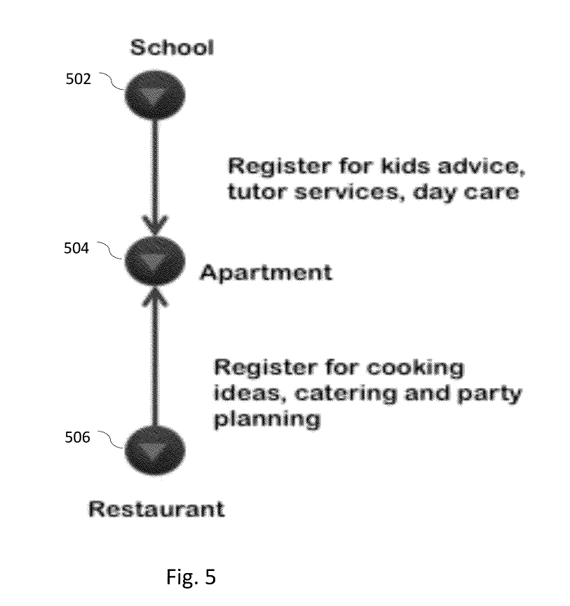

FIG. 5 illustrates message filtering within interconnected social groups. In an embodiment of the invention, a social group can specify set of services and interest a given social group is interested in participating. Based on this information, services and messages to connected mini-worlds are limited.

For example, as shown in the FIG. 5, a school social group 502 is connected to an apartment social group 504. The apartment social group 504 is also connected to a restaurant social group 506. According to the invention, the school specific can specify that it is interested in kids and education topics. This limits the school social group to these topics and filter any posts from coming to the school social group from the apartment social group. When a service request is made by a social group, a cyclic connect graph is constructed, using well known computer science algorithms like dijkstra's however, not limiting to the scope of the invention. In this graph message is sent only on links which have proper permission, as described by role based access control. In some embodiments facility is provided for message propagation speeds. For e.g. traverse up to 5 connected worlds per day or post it to communities within 50 miles.

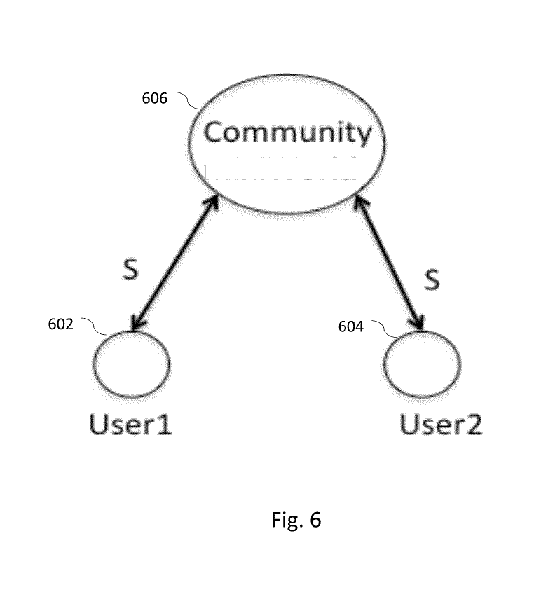

FIG. 6 illustrates a specific member to member communication as per one embodiment of the invention. As shown in the FIG. 6 two member User1 602 and User2 604 are connected to a community social group 606. If the users 602 and 604 are not directly connected to each other, then each user can only see public information of other user. Only after connecting with that user, information with shared or owner level privilege might be accessible. Two users who are not connected via any graph will not be able to reach directly. However, paid service, or by requesting permission from connecting set of social group in a graph is allowed. For e.g. If User1 602 who is not directly connected to User2 604 can request to view User1's 602 information by paying certain amount to community social group 606 to which both User1 602 and User2 604 are connected. To request for User1's 602 details the User2 604 might be required to register himself. This can be done by filing up of an electronic form by the User2 604, to register himself to the social group 606.

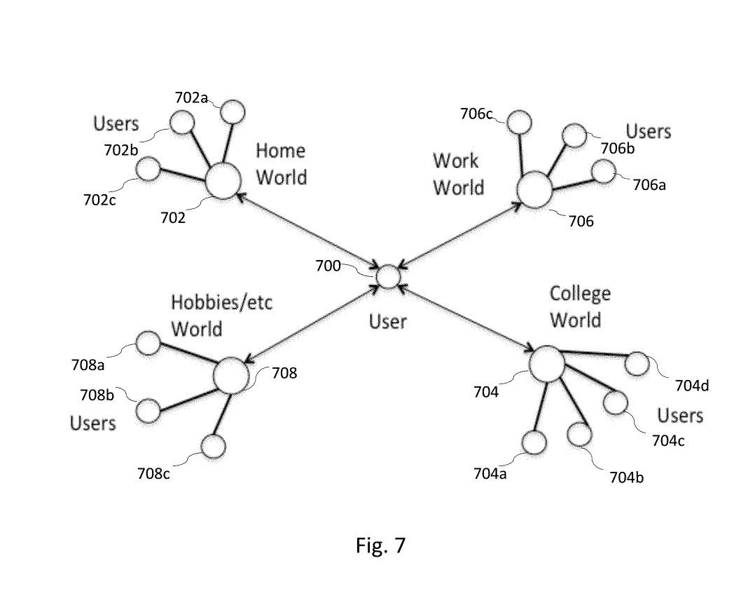

Referring to FIG. 7, as per another embodiment of the invention an individual 700 can also be a social group. In a real group user might end up with set of groups. For example, home 702, work 706, college 704, Hobbies/play 708 etc. A User will have friends, family and acquaintances at each group. In an embodiment of the invention the user 700 can post a specific message to his work group 706 which will be only accessible to users 706a. 706b, and 706c connected to the user 700 through his work group 706. Similarly the user can post a specific message to his Hobbies group 708 which will only be accessible to users 708a, 708b, and 708c connected to the user 700 through his Hobbies group 708. Further, the users 704a, 704b, 704c, and 704d can also see those posts which the user 700 posts to his college group 704. Also, the users 702a, 702b, and 702c can also see those posts which the user 700 posts to his Home group 702.

This setting allows the user 700 to post message to a selected communities to limit the scope of a given information. In addition, system automatically creates set of useful lists, such as all friends, family, friends at home, friends at work, professional network and the like. This enables the user 700 to be selective and share information with these communities. User 700 can use traditional methods such as email to post information to these communities as well.

However, in another embodiment of the invention the user 700 can also decide to share some information between more than one connected groups. For e.g. he may share come information with both the home group 702 and the college group 704 simultaneously.

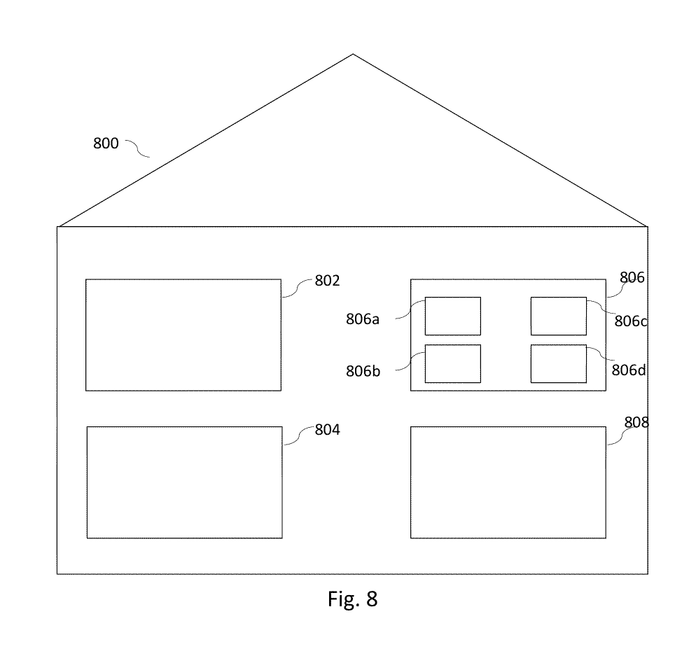

Moving further to FIG. 8 which illustrates formation of various sub groups 802, 804, 806, and 808 within a social group 800. In an embodiment of the invention however, not limiting to the scope of the invention, a social group 800 can be a shopping mall. Since a shopping mall may comprise of many shops hence the mall entity 800 spanning entire mall may not meet the needs of visiting users. Hence, various smaller virtualized sub entities are created for individual stores, brands, etc. within the virtualized mall group 800. In an embodiment, the virtualized mall entity 800 can be further divided into a pharmacy sub group 802, a Daily needs sub group 804, an office supplies group 808, and an electronics sub group 806. In an another embodiment of the invention the electronics sub group can also be further divided into various sub groups like laptops sub group 806a, a washing machine sub group 806b, a television sub group 806c, and a mobile phone sub group 806d.

Message Propagation within the Interconnected Social Group System:

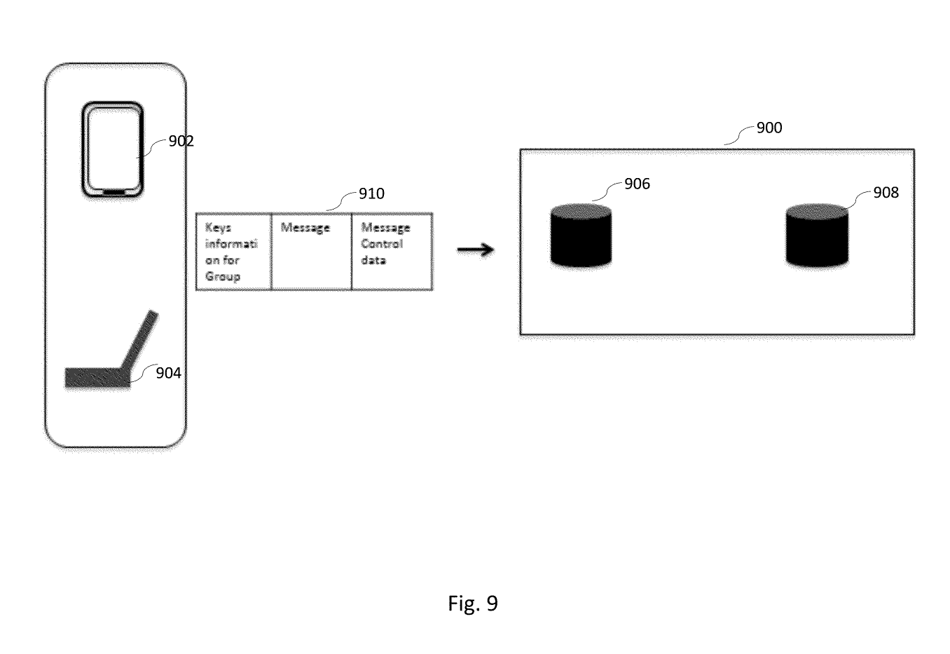

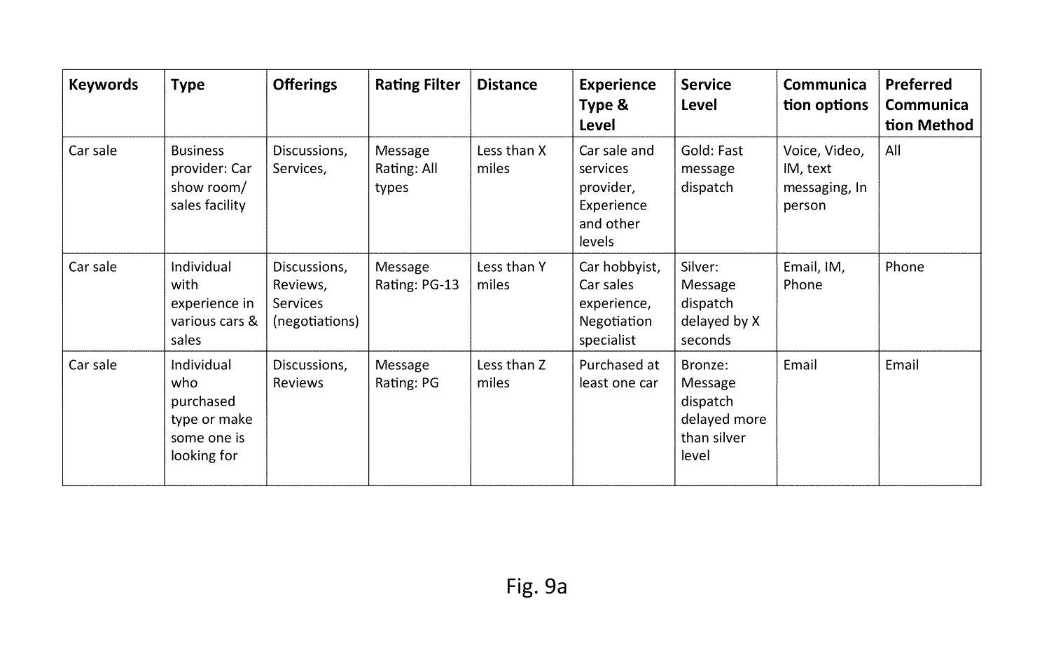

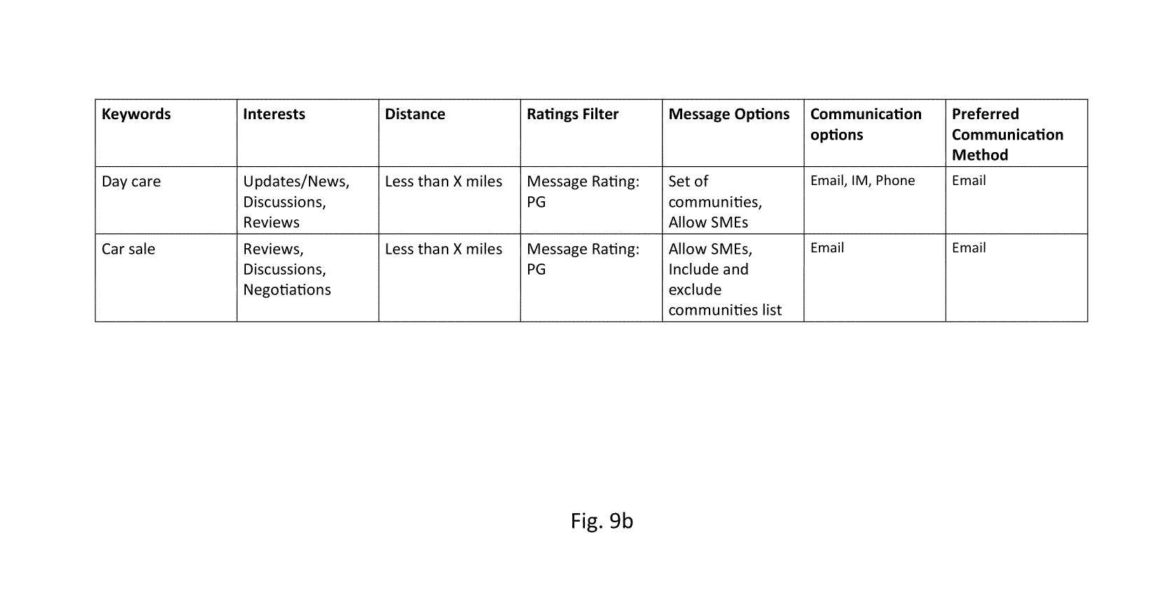

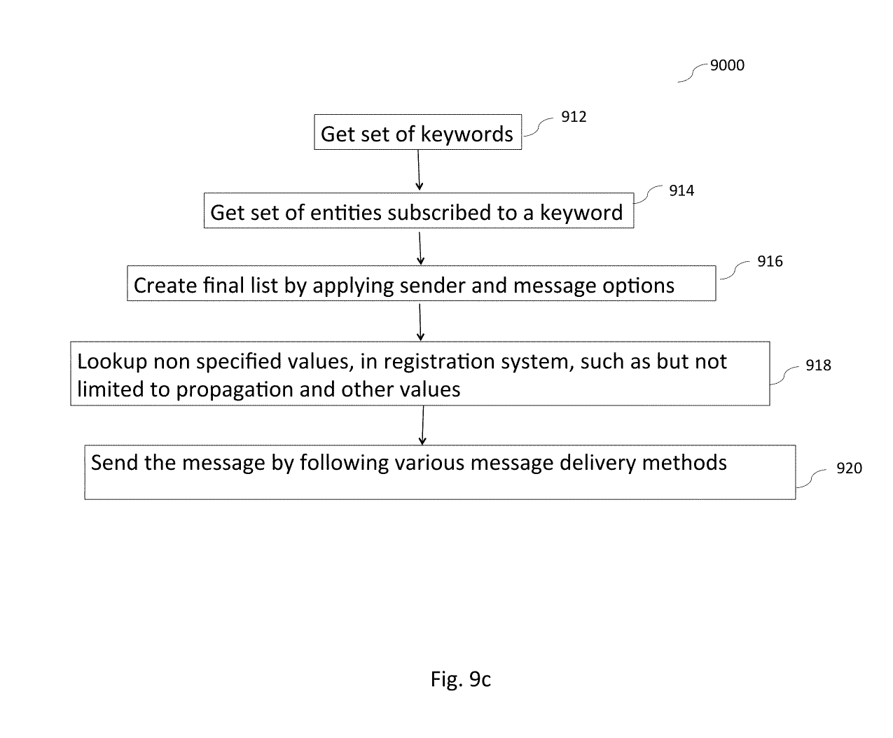

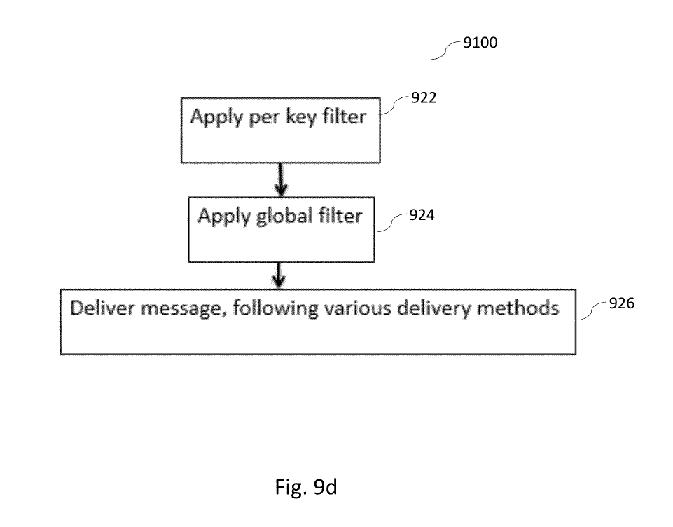

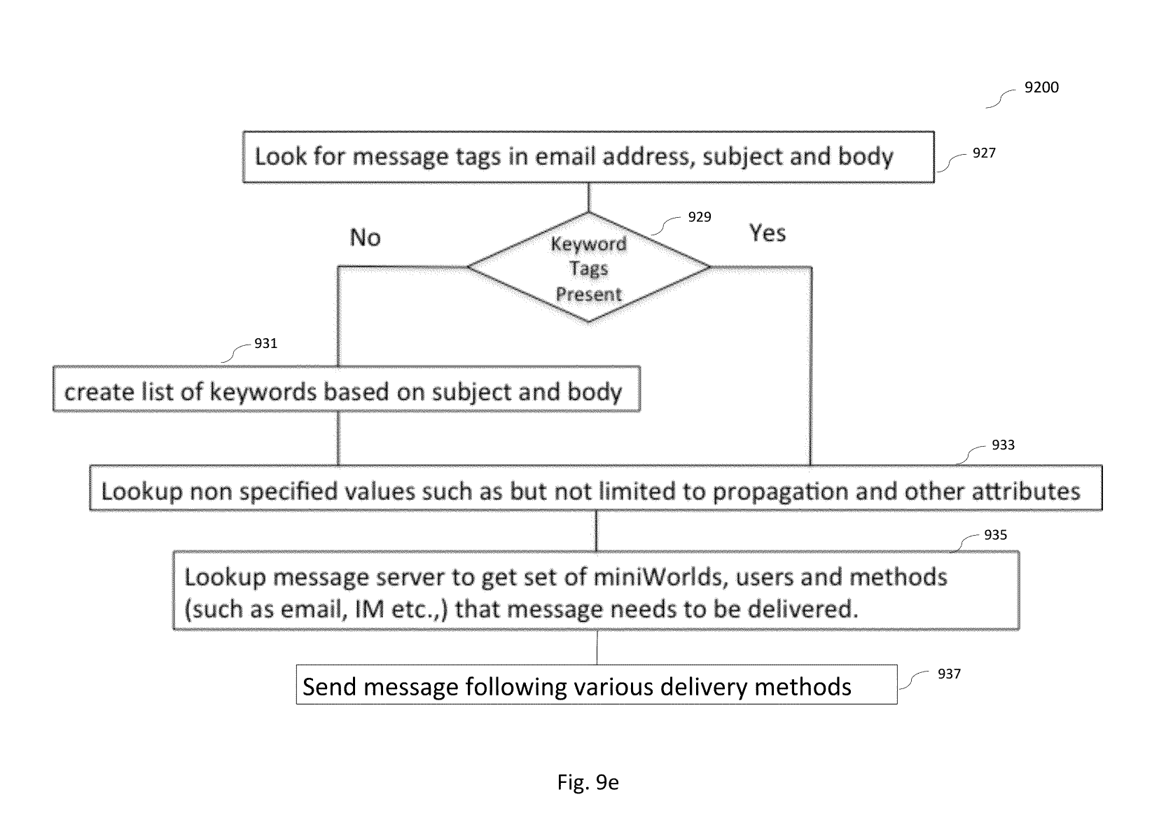

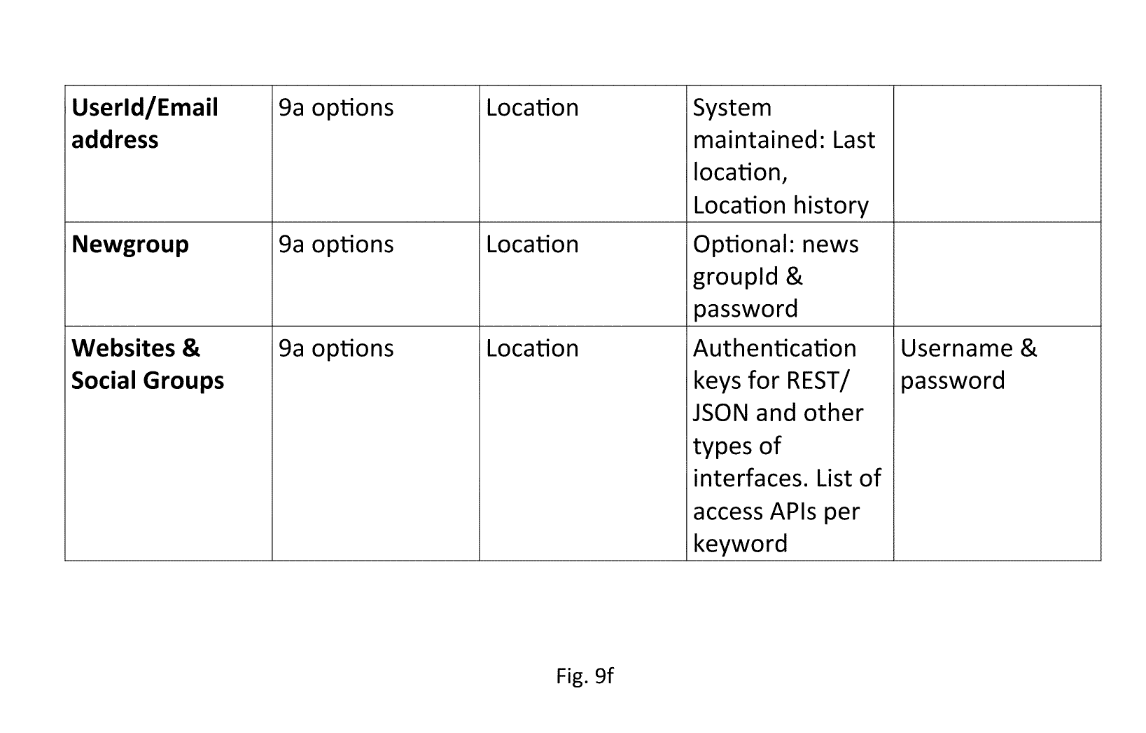

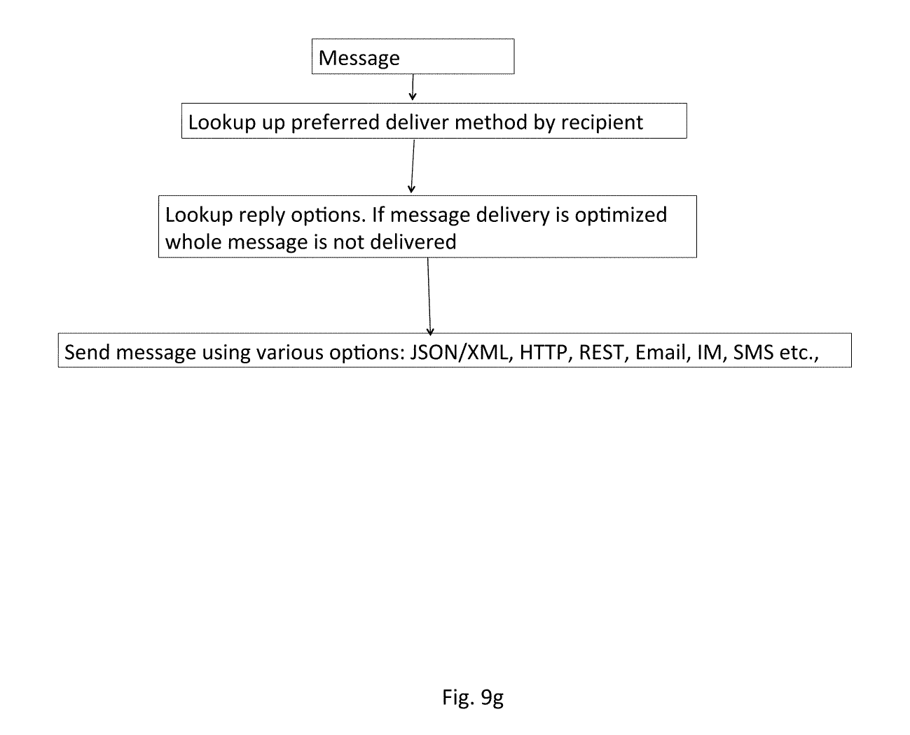

According to an embodiment of the invention a user can register himself with the system server to lookup various social groups that may provide information about certain interest areas of the user. Referring to FIG. 9 which illustrates a message server 900. The user can register for keywords of his interest with the message server 900 through his computing device 902 or 904 by sending a message 910 in a specific format. The message 910 can contain information like keyword information and a message control data (explained later). The computing device can be however, not limiting to the scope of the invention a mobile device, a laptop, a personal computer, a personal digital assistant, a tablet, or a car's system. Further, the message server 900 contains a user and group registration database 906. The user and group registration database 906 stores various information about users and the social group. Further, the message server includes a message database 908 which stores the various messages. In some cases registering for keywords might need user or owner approval process (as explained in FIG. 4). There could also be paid groups, i.e. subscription requires a fees.

Users participate in groups either to request information or to provide information on a given topic of interest. To simplify the description following terminology is used.

Provider: Refers to entity who wants to offer information.
Requester: Refers to an entity who wants to provide information for a given topic.
It should be noted that these terms are used to simplify the description. In real world, roles of any given user change i.e. a user might contribute on one topic, but request information on other.
A provider registers set of keywords i.e. groups. For each set of keywords provider specifies one or more of the following attributes.
Keywords: Set of keywords of interest
Type: Type of provider. Eg. Business, Individual etc.,
Offerings: Set of sub services offered for a given keyword. Eg. Car dealership offers participation on “car sale” topic by responding to discussions and of course providing physical service of selling a car.
Rating Filter: Each message is given a rating to indicate suitability to given audience. Eg. Suitable for adults, kids, teens etc., Message with a given rating or lesser is accepted by provider.
Distance: Physical distance or area that a provider is willing to serve
Experience Type & Level: List various experiences and also expertise level for each. For example: Individual offering “car sale” help can describe experience as Car hobbyist, Car sales experience, Negotiation specialist
Service Level: Provides various guarantees for message deliver. For example, Gold, Silver and Bronze level. Gold level delivers discussion on topic immediately. Silver delivers message with a delay of 10 mins and Bronze with even more delay. Or in some embodiments Gold member is allowed to participate is X number of discussions. Silver member is allowed on even less and bronze member is allowed on even less number of message
Communication options: Indicate other communication methods user is willing to offer for a keyword. Eg: Voice, Video, IM, text messaging, In person. This is typically useful if user wants to follow-up on a discussion to get additional clarity. For e.g. as depicted in FIG. 9a the table lists set of attributes the provider register for “Car sale” keyword.
A requester registers set of keys words i.e. groups. For each set of key words provider specifies one or more of the following attributes:
Keywords: Set of keywords of interest
Interests: Set of sub services user in interested in for a given keyword.
Rating Filter: Each message is given a rating to indicate suitability to given audience. Eg. Suitable for adults, kids, teens etc., Message with a given rating or lesser is accepted by provider.
Message Options: Provide various conditions that need to be satisfied for message delivery and reception.
   For example, FIG. 9b depicts a table that enlists a set of attributes that requester register for a given keyword.

To simplify keyword or group selection, in some embodiments, When message is composed, text is analyzed to match various existing keywords user is subscribed and world has defined to suggest various keywords.

To simplify keyword or group selection, in some embodiments, system automatically suggests few keywords by taking following into account:
Maintain histogram of all the keywords used at a given miniWorld
Maintain histogram of all keywords used by various user background: age, gender
Maintain histogram of all keywords used by a miniWorld type and per-user
Correlation index is also maintained between keywords. Eg. If a keyword X is registered than what is the likelihood that keyword Y is registered. (well know data mining methods for “Correlation clustering” can be used)
Dictionary terms i.e. Synonyms and others are automatically included or suggested.

It should be noted that additional information might also be included to make such recommendations.

### Message Delivery Options:

When the message 910 is composed, various options can be specified which helps in sending the message 910 to right audience. In accordance with one embodiment, the format of message control could be the following:

MessageId: Unique Id per message
TimeStamp: Global time stamp eg. Unix time stamp
Sender information: Sender Id
Explicit recipient list: Explicit user or group lists
Keywords set: Set of keywords associated
Subject: Message subject
Message: Context is encoded in HTML or MIME formats as needed

Also, FIG. 9 shows the format of the message 910. It should be noted that including other options is also possible. In addition body of the message can be encoded so that other applications can be used to read and display it to the user. For example, MIME type encoding (e.g. HTML). In addition message can indicate explicitly which application should be used to parse a given message. To reduce the information flow, instead of delivering the message, next to the message a count is indicated to show how many replies have been exchange. Once the user click on the message, information is fetched dynamically and shown.

### Message Sending Logic:

Based on the various keywords specified in message and message control as shown above and in FIG. 9, a set of receiving entities is gathered. To these entities message is delivered. This method 9000 is depicted in FIG. 9c. At 912, the set of keywords is gathered. At step 914, a set of social groups subscribed to the keyword are listed. Further, at step 916, a list of senders and their messaging options is enlisted. Finally at step 918, the message is sent using delivery methods as suggested by message control data.

### Message Receive Logic:

Each message receiver can specify various options as listed above per key word. In addition global filter options can be specified as well. Through this facility user can specify general rules that apply to all messages. For example, user can specify not to receive any message with a rating higher than PG. Also, user can block certain users or communities. If messages passes both the per-keyword options and global options then it is delivered following the delivery methods. FIG. 9d depicts the message receive logic 9100. At step 922 a key filter is applied as specified by message control data. At step 924, a global filter may be applied. Finally at step 926, message is delivered using the delivery method specified in the message control data.

### Message Propagation:

In another embodiment of the invention the message control that can be used to provide option to propagate the message could be as follows:
Include miniWorlds list:
Exclude miniWorlds list; Relationship rules
User preference: Male, Female, Age etc.,
Background/Interest filters: Tennis players, High tech workers
Activity based: i.e. recently brought stroller, had baby etc.,
Auto expand: True or False
Auto expand rate: X miles per day, N worlds per day, other formats are possible
World count limit: Max number of worlds to post the message
Delivery Options:

Propagation method is measured in worlds per day. FIG. 9e shows visually how the propagation occurs. In one embodiment options can be specified to stop the message once a reply to the message is seen or when a world count limit is seen.

In some embodiments following options are provided

### Reply Options

As not all members of the group might be interested in a given topic, in some embodiments reply is only posted to persons who have opened ie viewed the message. For users who haven't opened the message, next the message heading, count option is indicated to show how many replies have occurred per conversation. This helps in reducing the resources needed for sending the message.

### Tracking Messages

In some embodiments on adding various keywords reachable user count is shown as feedback. In addition different metrics are tracked per message i.e. which message is viewed, how many links within a message are clicked. Also, message subject and content keywords to user viewing the message are tracked. This helps in providing feedback to user as to which message might be important to the user.

### Tracking User Activity

Various user activities are tracked and maintained. This enables in providing various services such as ability to contact a user who purchased a given product to gather direct feedback etc., Through social group system or through information got from else where a list of product purchases, places traveled, events attended, location history, checkins to places are tracked. Based on user activity various level of expertise are assigned to user.

For example, using this information message can be selectively posted to all members who have kids. Or to post a job posting which matches a member profile.

### Business Aspects

Facilities are provided for SMEs to register for different keywords of interest.

This enables SMEs to directly engage on topics of expertise and contribute to community and thus build business. Different base prices are assigned per keyword. SMEs are provided options to register based on factors such as, but not limited to, message count, physical geographical area and others. SMEs can bid to receive messages from the target audience, identified through registration parameters and keywords. In some embodiments highest bidder is assigned Gold service level, followed by Silver and followed by Bronze. Other lower grades are also possible. In one embodiment Gold service level entitles ability to receive more number of messages for a given keyword than silver. In one embodiment message is delivered to Gold service level much earlier than silver level service. For example, Gold service level gets posted a message on keyword registered 10 minutes earlier compared to a silver level member. In one embodiments Gold service members can receive messages via SMS or IM notifications and message when message is posted. In some embodiments, additional premium is charged if the user is not directly connected to the SMEs network.

In addition to receiving messages, SMSs and others can advertise based on the keywords. SMEs and others can register to set of users based on various registration parameters, such as but not limited to keywords, physical area etc., In addition other individual and group attributes can be used to further target ads to selective group. SMEs and other can bid for the keywords. In some embodiments minimum bid is assigned. Ads from the bidders is shown in relative order from high to low bidders right next to the message. In some embodiments user is charged only if a given message is viewed. In some cases, only if the message is acted on i.e. user clicks on links.

By using topic of discussion i.e. by keywords ads are customized and delivered along with a given message. Businesses and like can bid per keyword and additionally per geographical area to get their ads displayed.

In some embodiment if request is made to deliver message to non-connected worlds, for example by using the distance criteria mentioned in FIG. 9a, then the user may be charged for each community that she is not directly connected to.

In some embodiments user is charged by distance of message delivery. For example, if message is delivered to communities within 5 miles, then charge 5 units of currency. If message is delivered to communities within 10 miles, then charge 10 units of currency.

To get faster response with each message option is provided to assign reward in terms of currency or virtual reward by transferring points from requester to replier. For example, 10 units of currency is assigned to solicit feedback on specific model of a car. If multiple users reply then options are provided to distribute the reward equally for all respondeds, or distribute rewards equal to a first set of users or manual method through which user can assign the rewards to each responder. For example, through points mechanism user can assign 100 points per message. If 10 people respond, through the uniform distribute option, user can distribute 10 points to all respondeds. As user responds to given topic or topics, user expertise on a given topic is automatically flagged. In addition, if a given a responder is assigned expertise if she is also assigned rewards by the sender. More weightage is given to rewards to adjust to user expertise level from low to high. In addition, each message is given usefulness flag. Higher the usefulness higher points are assigned to experience level.

### Virtual Communities Split by Geo

As specified in geo social group, a given keyword can be organized a social group arranged per area.

### Search Results

One of the challenges in a group setting is that folks tend to ask same questions over and over again. These might have been answered in same group or else where. Connecting with users with same interest solves it to some extent. However it is still possible that user may not have time to search which results in duplicate email. To help with such situations, when user sends the message, system tries to automatically search messaging system, internet and other possible data sources. Search terms are obtained from the message topic, subject, message body, user preferences and user profile. Various Natural Language Processing (NLP) techniques are used to decide if the topic of discussion is a question, review, recommendation etc., i.e. it is some topic that can be answered in some authoritative way, unlike debates. In some embodiments, if the topic of discussion is say view point sharing. For example say political debate etc., search step is skipped. Results are replies to the user via email or in some cases to the same message thread. In web based systems, results are added either at the end of the topic or system automatically generates appropriate reply back by blog post reply and other mechanisms. In addition when user types in the subject, suggestion is prompted to user to show the relevant search results. Once the message subject is composed possible answers are shown. In addition, list of SMEs serving for a given SMEs & Users, along with services they offer, are also shown as possible sources to get a given topic answered quickly.

### New Keywords

When new keywords per-message are created, user can indicate the relationship to existing keywords. Eg. User can state that folks subscribed to existing keywords A and B might be interested. In such cases message is send to all these groups. Users can accept to receive additional message for these words. In some embodiments message is send to all users, as specified in message settings. Once user get the message, they can opt to join this or not.

### Removing Keywords

By using the tracking feature i.e. maintaining history of keyword usage in messages composed and messages user has opened, active keywords list is maintained. If user has not looked at a keyword for a while, after a cut of period (say one week), message count activity is shown, instead of delivering the messages. Optionally in some embodiments summary of all discussions is also shown.

### Data Visualization in Space Constrained Environment

On the messaging client mobile application discussion per-keyword are organized into small visual block so that user can quickly get to them and see the top questions etc.,

### Feedback to the Users:

To encourage good discussion users are allowed to rate a response or posting. In addition to further encourage good responses users might be given credits in terms of points or money. In addition to recognize the contributions badges and points are displayed next to user profile.

### Trust Building

SME and users can participate in various topics of discussion. Based on various factors such as number of replies, quality of replies, badges, points assigned for various interactions, Trust level of SME and users are adjusted.

### Ads by Keyword

For each message in some embodiments using information such as, but not limited to
Topic of discussion,
User profile and history of ad clicks,
Aggregate profile of users at a given group and ad clicks,
Social group settings,

### Location,

Time of day and seasons,
News and trends,
And other information

Various ads are suggested. Ads clicks are tracked in order to further refine future suggestions

### Private Conversation Made Public

A group might provide different levels of access i.e. certain pieces of information might be only visible to owners, certain information to the members and certain information to all the users.

One of the reasons is to provide privacy. In one embodiment SME and other users can register for different privilege level, after getting appropriate permission. In addition any given topic one or plurality of messages can be made public if all the parties involved in conversation agree to it. Users are rewarded for contribution to the community through the rewarding system.

### Additional Interactions

Once a sender gets response, in some cases sender might want to have additional communication with responder. For communicating various options are provided such as Instant Messaging (IM), Messaging or Email, Chat, Phone, Conferencing and like. System allows users to communicate with each other while maintaining individual contact information private, such as email Id, Chat Id, Phone Id etc. To achieve this following method is followed. Sender sends message to responder requested for a desired method of communication. At this time receiver has option to view the sender's profile. Get basic information such as name, location and other information. Facilities are provided through which responder can request additional information form the sender, such as some information about the user profile, past interactions with others in community etc. Once this is complete and responder accepts the request, desired mode of communication can take place between two audience.

Ability to communicate to user who has same interest anonymously

### Legacy Email Interoperability:

User using traditional email clients to inter-operate with messaging service can include a specific email address. For example messager@somedomain.com; This delivers the message to the messaging service. In some embodiments, messaging system automatically tries to extract the keywords from the content of the message and subject lines, as shown in FIG. 9e. In some other systems keywords can be specified in the recipient list using standard @ sign. For example, childcare@domain.com. Note: domain.com is used just as an example. Other names are possible. As there could be conflict with a keyword and userId at a site, to help with that, in some embodiments, reserved prefix can be used. For example #topic@domain.com or *topic@domain.com. Other formats are possible. In some embodiments specify it via subject or message body using special tags.

For each user a registration portal is provided. For example www.somedomain.com/messenger through which user can specify the default attributes to use. For example, default distance per message, connection based rules etc., In addition user can also specify the attributes to be used with each keyword. User can use this portal to track rewards, points and re-charge points etc. If the user hasn't created settings or doesn't have account then group level settings are used. If not global defaults are used.

Logic of extraction different tags that are useful for message system are shown in FIG. 9e. In step 927 system tries to look up various messaging options by paring the email, subject and body

If no tags are specified then tags are extracted from subject and body as showing in 931

Message server settings for user, group and global values are looked up in the messaging server databases as shown in 933

Finally message server is lookuped to gather all the recipients of the message. Note: if there are only few persons from a groups are interested in the mail, then mail is directly delivered to that persons

In some cases group server instead of sending the message to existing group alias. for example, somegroup.com message can be send to the new alias i.e. messager@somedomain.com. Based on various setting message is delivered to interested parties.

Mechanisms are provided to enroll different groups and specify various attributes. When the mail is send to messenger service if only few people are interested in a group, then email is directly delivered the individual users.

For users using some email, for example messager@somedomain.com message is send back to indicate the configuration used, along with statistics. Also, once every N messages user is send a message to indicate to migrate to new settings. In addition with each message delivery a comparison chart and statistics are provide to how many additional users a person is able to reach compared to the traditional group the user might be using.

SMEs using traditional communications methods can use the same portal to register for various keywords, distance and other attributes and bid for users for a given set of attributes. While bidding for physical area as there could be region based conflicts, user will be shown a map type of interface through which user can figure out the amount charged to advertise or communicate in a given area.

Through this portal SME can register per-keyword the method of communication such as SMS, IM, email etc.,

User can register the set of keywords using the mobile device. With message various attributes are specified, these are carried forward using JSON/XML encoding. If the receiver is email, then header are removed and message is forwarded in appropriate format

Default parameters for different legacy systems are stored as specified in 9f. It should be noted that it is not possible to describe all the values needed.

### Legacy Migration Support

Messaging system can interface with blogs, email and web sites. This is shown in FIG. 320. High level architecture pictures is shown in FIG. 316. Recipient can be email address, web sites or blogs. Source of message can be individual email or group email address. In one embodiment messaging system described in this invention can be embedded into email server or can work with email server as a plugin.

Migration: Step1: To help migration from newsgroup or blog and others systems to new system social group Message system is added as one of the users; For example, by creating a user account for it. This enables the system to download all the message and build the record for that email system.

Migration: Step 2: System automatically connects to existing email, blog and other system. Gets list of users for a given group. System automatically creates social group for each user. Adds the keys for each group parsed. To help folks migrate, a new email group address is created. This acts as interface to the messaging system. Folks can continue to use email to send and receive messages via this newly generated email address. In addition messages from each member are analysed to see which keywords a given user is potentially interested in. These are added to user setup automatically. Once user migrates to messaging client then additional features and functionality will be provided.

Destination can be messaging system. People using the email system are reminded to migrate to the message client by appended a reminder text at the bottom of the text.

### Sale Support:

In a group setting typically folks want to trade items. To increase the changes of trade a seller for example may want to list an item in neighboring communities, say within 5 miles. In addition, there might be cases where seller want to post an item for a sale but wants to exclude posting this to his family. To support such a facility, messaging system infrastructure is used to implement the sale support. Messaging facility as shown in FIGS. 9a and 9b provides various controls through which user can get the desired behavior.

For example, through this facility, in addition to social rules, user can leverage the profile information to customize the posting. For example, post a baby item for sale to persons who had baby recently. In addition various parameters can be mentioned such as distance, social relationships, users trustworthiness etc., to refine the item sale posting.

Sale Correlator: In a community setting, it is common for folks to post several items for sale such as tickets for shows, hotel deals, rental for weekend etc. Also, as number of posts are typically high. So, it becomes hard to comprehend all the sales and also to identify related sales. For example, a person who is going for a weekend gateway might also be interested in a popular show that is going to occur at nearby place. Also, a person who brought say a black and white desk, might also be interested in black and white chair. To help with such situations, in one embodiment, miniWorld sale system in addition to providing facility to post items, and providing stats on how many people viewed a posting, clicked on links etc., it provides facility to show relevant transactions together. For example, for events such as show tickets, it tries to looks for hotel booking, nanny services and other information. In cases where a particular item of service is not available in the community sale posting, search is done to find such product or service at close by vicinity. To the user data is presented as a package which makes it easy for user to comprehend and purchase. Based on this information trip package are created. Users are shown weekend trip packages. If appropriate items are not available then ite from other vendors are listed.

For folks looking for multiple items going through these item is time consuming. Instead a simpler option is provided where a model of different rooms Eg. living room, kitchen, office room etc., are provided. Various picture of items in the sales listing are gathered and arranged to create a complete view of how different rooms look like with various item. System gathers furniture color, physical measurements, make, vendor, year and others attributes to suggest based on Color constrat, Color uniformity, Themes: Modern, Classic etc. User can select the style preferred or based on user interaction this is determined. User can upload picture of their target room. System can show how the furniture will look like in user room. Ability is provided to user to pick a given furniture in room and click through to see different alternatives. Videos/3D view of each item is provided so that user get good feel of the product. If suitable product is not found then in some cases new products, from other vendors, can also be listed along with products that miniWorld community want to sell

Typically sale transactions involving non established business entities for example individual sales. For such sales typically folks need to arrange for moving services. Facilities are provided through which local moves are shown next to deal. In addition folks who want to share a moving service i.e. rent and share can connect through intent world to cut down the cost of moving.

Based on feedback of each transaction trust worthiness of seller and buyer is updated i.e. based on items involved, number of transaction, purchase amount, user to user feedback trustworthiness is adjusted. Also, in order to provide additional comfort and visibility to the sellers and buyers involved in a transaction, location safety estimate is provided. To achieve this general safety information of a given place is shown, which is obtained through public crime records obtained from government offices such as police department. In addition history of know transactions at a given place are used to adjust the public record rating.

When a buyer and seller tentatively agree to do a transaction, buyer or seller can request references from the previous buyers and sellers from previous transactions. If previous transaction does not exist, then user can request referrals from friends of buyer or seller. Sender sends message to buyer about referral from friends, buyer can then select some of his friends for reference. In addition, when buyer and seller agree on sale, both of them can see each other mini-world so that they can gain mutual trust.

User gets charged on reading the review. Business gets charged when user requests connection to that business/product/item.

### Advice Service

Subject matter experts (SME) are experts in a given area. Example: Doctors, Technicians etc., To facilitate easier way to obtain services from SME and also to build SME reputation, SME can connect to mini-world that they want to service. example: Physician signing up for apartment mini-worlds within 5 miles radius of her practice. When user posts the question on this subject, this can be handled by the connected SMEs. SME can forward a given request to their connected worlds to service the request.

### Voice & Video Service:

In order to encourage community interaction and increase awareness, facilities are provided so that user can broadcast video live to the directly or indirectly connected users of the mini-world. Example: Just like a food show, which shows Chef's making a dish. Local restaurant can broadcast video to the communities they are serving to inform and engage. In addition to live video, offline video content is made available as well. For example, say self help video eg. How to put grout in kitchen sink. These types of information will benefit the community.

### Interactive (Games, Quizzes Etc.) Services:

To encourage community interaction, in a directly or indirectly connected mini-world users can interact with connected users to play live games (also provision is provided to connect with all users to play interactive games, which can accommodate delayed communication Eg. playing one game of chess over one year!).

Simple facilities are provided to user to allow for interactive quiz (where user sets the questions, with multiple choice. Other forms of questions are supported as well). This information is pushed to the connected user for live event. This mechanism can be also utilized to send out surveys.

Quiz questions also allow for multi-media elements to be included as well. Quiz questions can be composed live or can be done in offline mechanism.

In addition to included games, it is possible to user the list of users connected to play other games, which leverages user presence information from mini-world. Methods of suggesting friends and related worlds:

If connected users are connected to dis-joint worlds, then the disjoint set is presented to each user as a suggestion to join. For, example, two friends A and B are connected to worlds {1, 2, 3} and {2, 3, 4} respectively. In such cases, A is recommended to join world {4} and user B is advised to join world {1}. Using standard machine learning methods, a profile of users is maintained for each world i.e. categorize the users based on user profile, worlds the users is connected to, location (with distance metric). Based on this learning data, new users are suggested to join a given world.

### User Involvement:

One of the benefits of miniWorld is it promotes interactions. Users at various communities can register as volunteers for various incidents, subject matter experts for some topics, other options are possible as well. For example, in one embodiment user can register for following set of volunteer activates: Volunteer Security: Participates in neighborhood watch, helps to act as first responder in case of help is requested

Volunteer Medical: helps to act as first responder and/or when relevant help is needed
Volunteer First Aid: Can provide first aid help
Volunteer Fire: can provide help with fire or knows the knowledge as to what to do
Volunteer Transportation: Provides transportation serves and help when requested
Volunteer Tutor: Can provide tutoring services
Volunteer Caretaker: Can provide caretaker services
In other embodiments home community can register for
Neighborhood watch
Car pool etc.,
   To encourage user behavior Volunteer and community badges are given for various activates. In addition, giving points rewards user participation. In some embodiments options are provided for users to reward a given user through local currency.
   In addition to in some embodiments, top contributors for various miniWorlds are rewarded.
   In addition, badges and points can also be used to incentive and encourage user participation. Example: Every time user responds to a request, a point is given to the user. Based on various user activities, in addition to points, user is given a badge. Example: Top contributor, also, showing number of positive feedbacks they have got.

In one embodiments volunteers are given karma points, which can be converted to local currency. Regular points can be converted to local current as well, in some scenarios. In addition in some embodiments, revenue generated by the system at a specific community is given back to the community either directly for each member, or by sponsoring local events.

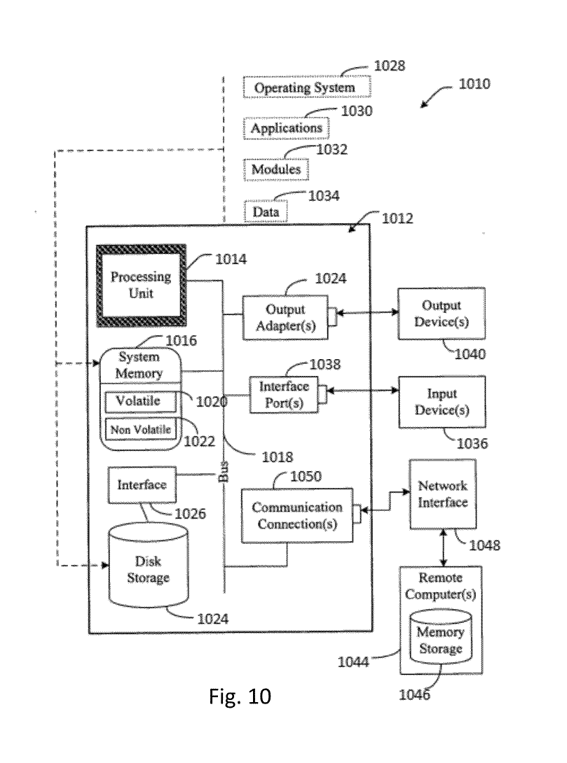

With reference to FIG. 10, an exemplary environment 1010 for implementing various aspects of the subject invention includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, an 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/nonremovable, volatile/nonvolatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the subject invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers among other output devices 1040 that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

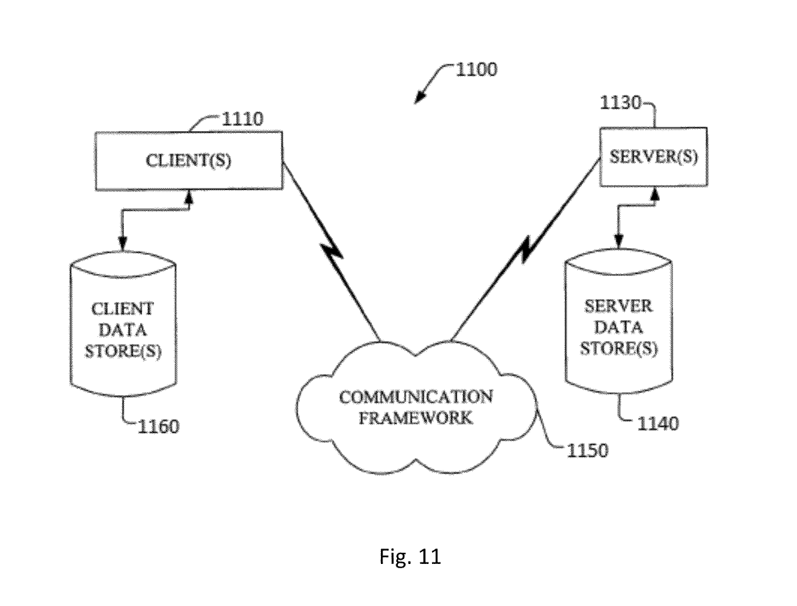

FIG. 11 is a schematic block diagram of a sample-computing environment 1100 with which the present invention can interact. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g., threads, processes, computing devices). The servers 1130 can house threads to perform transformations by employing the present invention, for example. One possible communication between a client 1110 and a server 1130 can be in the form of a data packet adapted to be transmitted between two or more computer processes. The system 1100 includes a communication framework 1150 that can be employed to facilitate communications between the client(s) 1110 and the server(s) 1130. The client(s) 1110 are operably connected to one or more client data store(s) 1160 that can be employed to store information local to the client(s) 1110. Similarly, the server(s) 1130 are operably connected to one or more server data store(s) 1140 that can be employed to store information local to the servers 1130.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of message propagation within a social group formed real time, the method comprising;
receiving a registration request from a user, wherein the registration request comprises interest information of the user;
analysing the registration request of the user, wherein the registration request is categorized into various categories of registration requests;
identifying relevant information based on the registration request; and
providing the relevant information to the user.

2. The method of claim 1, wherein the registration request comprises groups to which the user wants to subscribe.

3. The method of claim 1, wherein the user is an individual.

4. The method of claim 1, wherein the user is a business entity.

5. The method of claim 1, wherein the registration request contains information about means to deliver information to the user.

6. The method of claim 1, wherein the user registration request contains information about sources of information acceptable to the user.
